(19) United States
(12) Patent Application Publication
(10) Pub. No.: US 2017/0024940 A1
(43) Pub. Date: Jan. 26, 2017

(54) DRIVE DIAGNOSING DEVICE

(71) Applicant: OPTEX CO., LTD., Shiga (JP)

(72) Inventors: Junichiro OKABE, Otsu-shi (JP); Tsutomu USAMI, Otsu-shi (JP); Akihiko NAKAMURA, Otsu-shi (JP)

(73) Assignee: OPTEX CO., LTD., Shiga (JP)

(21) Appl. No.: 14/806,362

(22) Filed: Jul. 22, 2015

(51) Int. Cl. G07C 5/08; G01S 19/13

(52) U.S. Cl. CPC G07C 5/0808; G07C 5/0841; G01S 19/13

(57) ABSTRACT

The drive diagnosing device 1 includes a portable device main body 2, which is electrically powered by a battery 8 built in the device 1 and which includes a control unit for acquiring a driving behavior from the operation of an automotive vehicle, which has been detected by an operation detecting (acceleration) sensor 5 and then determining the driving behavior to thereby diagnose such driving, the device main body 2 being disposed at an arbitrarily chosen site within the automotive vehicle. The operation detecting sensor 5 is kept in a constant drive condition, and a driving behavior capture initiating unit 12 is provided for causing the control unit 6 to initiate the capture of the driving behavior from the operation detecting sensor 5 and for subsequently determining the driving behavior.

### BACKGROUND OF THE INVENTION

Field of the Invention

The present invention relates to a battery powered drive diagnosing device operable to diagnose the driving status by acquiring a driving behavior from an operational parameter of an automotive vehicle such as, for example, acceleration detected by an operation detecting sensor.

Description of the Related Art

The drive diagnosing device has hitherto been well known, in which a digital tachograph (cruising control meter) and/or a drive recorder is used to acquire the driving behavioral information of an automotive vehicle so that traffic accidents may be recorded and/or the driving behavior may be analyzed to diagnose the driving status.

The patent document 1 listed below, for example, discloses a sort of the drive diagnosing device for acquiring data descriptive of driving behaviors of a driver driving an automotive vehicle through the drive recorder and then analyzing and diagnosing, for example, driving propensities of such driver on the basis of the acquired driving behavioral data. According to the drive diagnosing device disclosed in the above mentioned patent document, as a behavior sensor the use has been made of various sensors such as, for example, an acceleration sensor and an imaging camera so that data detected in various vehicles in connection with a plurality of vehicles may be post-processed by an external personal computer or the like to diagnose the driving status.

Also, the patent document 2 listed below, for example, discloses a portable, but convenient drive diagnosing device of a type which is powered by a battery built in the device and is operable to acquire driving behaviors from the acceleration of an automotive vehicle, detected by an acceleration sensor mounted on the automotive vehicle, to diagnose the driving status through determination of the driving behaviors. The drive diagnosing device disclosed in the above mentioned patent document 2 eliminates the use of the various sensors, other than the acceleration sensor, and personal computers so that a microcomputer (control unit) built in the device can evaluate the driving behaviors.

### PRIOR ART LITERATURE

Patent Document 1: Japanese Patent No. 3229297
Patent Document 2: Japanese Patent No. 5200222

### SUMMARY OF THE INVENTION

It has, however, been found that in the conventional device, it is quite often that the automotive vehicle is driven to run inadvertently without the power-on switch being turned on and, therefore, a driving behavior at the time the automotive vehicle has started is no longer available. For this reason, in order to enhance the user-friendliness handlability of the device, a portable device may be contemplated which supersedes the use of any switch manipulation regardless of the start and termination of the driving, but which is electrically powered on at all times to keep the acceleration sensor active at all times.

If the acceleration sensor in the contemplated portable device referred to above is kept active at all times, the reliability of the driving diagnosis will be lowered because of difficulty in discriminating whether the detected change in acceleration has taken place while the device was mounted on the automotive vehicle or whether the detected change in acceleration has taken place while the device was removed from the automotive vehicle for transportation.

Also, if because of the built-in battery powered feature the device is kept switched on at all time, the need may be recognized to minimize the operational processing of a microcomputer (control unit), which requires the relatively large power consumption within the device, to save the limited available electric power of the battery.

In view of the foregoing, the present invention has been devised to substantially eliminate the problems and inconveniences inherent in the conventional device of a similar kind and is intended to provide a built-in battery powered, portable drive diagnosing device designed to save a limited available electric power while increasing the reliability of the drive diagnosis and also to enhance the convenience and handlability of the device.

In order to accomplish the foregoing object, the present invention provides a drive diagnosing device which includes a portable device main body comprising a control unit that is electrically powered by a battery built in the device and operable to acquire a driving behavior from operation of an automotive vehicle, detected by an operation detecting sensor, and then to determine the driving behavior to diagnose such drive, the device main body being installed at an arbitrarily chosen site inside the automotive vehicle. The operation detecting sensor referred to above is kept in a constantly drive condition and a driving behavior capture initiating unit is provided to cause the control unit to initiate capture of the driving behavior, after mounting of the device main body at the arbitrarily chosen site within the automotive vehicle has been detected, on the basis of detection of an automotive vehicle operation from the operation detecting sensor and to determine the driving behavior.

According to the present invention, driven by the battery built in the device, it is portable, and since the operation detecting sensor for acquiring the driving behavior is kept in the constantly driven position, the convenience and the handlability can be enhanced. Along therewith, since the mounting of the device main body at the arbitrarily chosen site inside the automobile vehicle is detected, the condition, in which the device main body has been installed within the automotive vehicle, and the condition, in which the device main body has not yet been installed at the arbitrarily chosen site can be easily distinguished from each other. Also, since after the mounting of the device main body has been detected by the driving behavior capture initiating unit, the capture of the driving behavior is initiated and the driving behavior is hence determined, the calculation in the control unit is minimized as small as possible and the power consumption of the battery can be minimized. Accordingly, the reliability of the drive diagnosis can be increased and the energy saving is planned for with the built-in battery powered, portable device and the convenience and the handlability of the device can be enhanced.

In a preferred embodiment of the present invention, the drive diagnosing device also may include an installation holder installed at the arbitrarily chosen site within the automotive vehicle and on which the device main body is removal mounted, and a placement detecting mechanism to detect the mounting of the device main body on the installation holder, such that the driving behavior capture initiating unit initiates the capture of the driving behavior, after the detection of placement of the device main body onto the installation holder, to thereby determine the driving behavior. In this case, since the mounting of the device main body onto the installation holder is detected by the placement detecting mechanism, it becomes easy to distinct a condition, in which the device main body has been mounted on the installation holder inside the automotive vehicle, from a condition in which the device main body is not mounted on the installation holder.

Preferably, the placement detecting mechanism may be comprised of a detection switch, a switch main body being disposed on the side of the device main body while a to-be-detected body is disposed on the side of the installation holder. In this case, on the side of the device main body, the mounting of the installation holder can be easily detected.

In another preferred embodiment of the present invention, the installation holder may be provided in a number of types, each type having a unique holder identifying element, in which case the device main body includes a holder identifying element recognizing unit to recognize the holder identifying element. In this case, since the type of the installation holder can be recognized for each, even though the installation angle changes according to the type of the automotive vehicle, it becomes easy to correct the acceleration data dependent therein and the driving behavior can be easily corrected.

Preferably, a plurality of the to-be-detected bodies may form the holder identifying element. In this case, with a simplified structure, the mounting detection of the installation holder onto the device main body and the holder identification of the plurality of the installation holder can become easy.

Also preferably, the operation detecting sensor referred to above may be selected from the group consisting of an acceleration sensor, a gyro sensor and a GPS sensor. Accordingly, the driving behavior can be easily acquired.

In view of the foregoing aspect of the present invention the present invention is powered by the battery built in the device and can be carried from place to place and the operation detecting sensor for acquiring the driving behavior is held in a constantly driven condition, the convenience and the handlability of the device can be enhanced. Along therewith, since the placement of the device main body at the arbitrarily chosen site within the automotive vehicle is detected, a distinction between a condition, in which the device main body is installed within the automotive vehicle, and a condition, in which the device main body is being transported and is not therefore installed, can be easily accomplished. Also, since by the drive behavior capture initiating unit and after the placement detection of the device main body, capture of the driving behavior is initiated and the driving behavior is hence determined, the calculation in the control unit is minimized as small as possible and the power consumption of the battery can be minimized.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIGS. 1A and 1B are exploded views of a drive diagnosing device according to a preferred embodiment of the present invention;

FIG. 2A is an exploded view of the drive diagnosing device as viewed from lateral side;

FIG. 2B is a structural diagram showing the drive diagnosing device in an assembled condition;

FIG. 3 is a block diagram showing the drive diagnosing device;

FIGS. 4A to 4C are schematic views showing a to-be detected body (holder identifying element) and a switch main body; and

FIG. 5 is a block diagram showing the drive diagnosing device according to another preferred embodiment of the present invention.

### DESCRIPTION OF THE PREFERRED EMBODIMENT

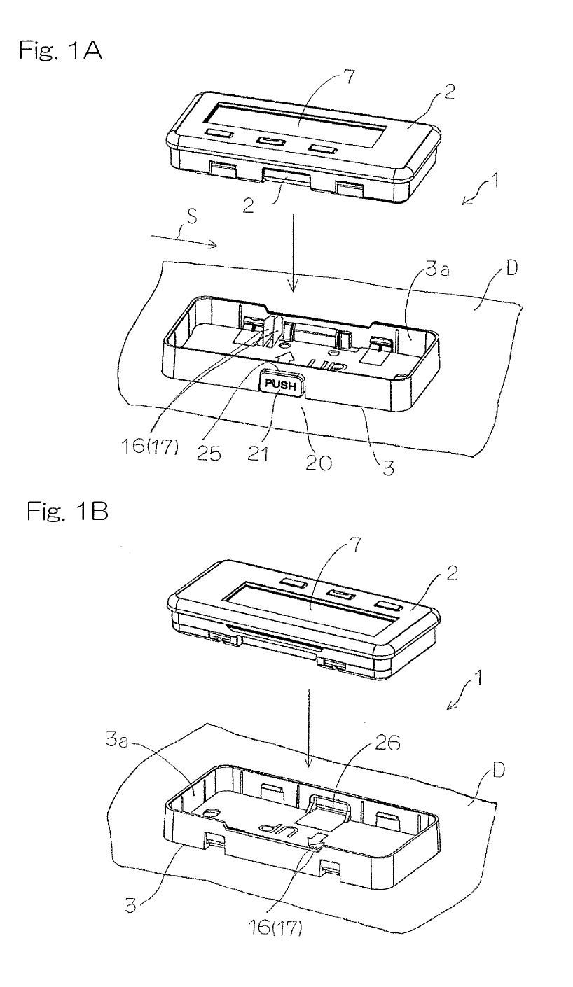

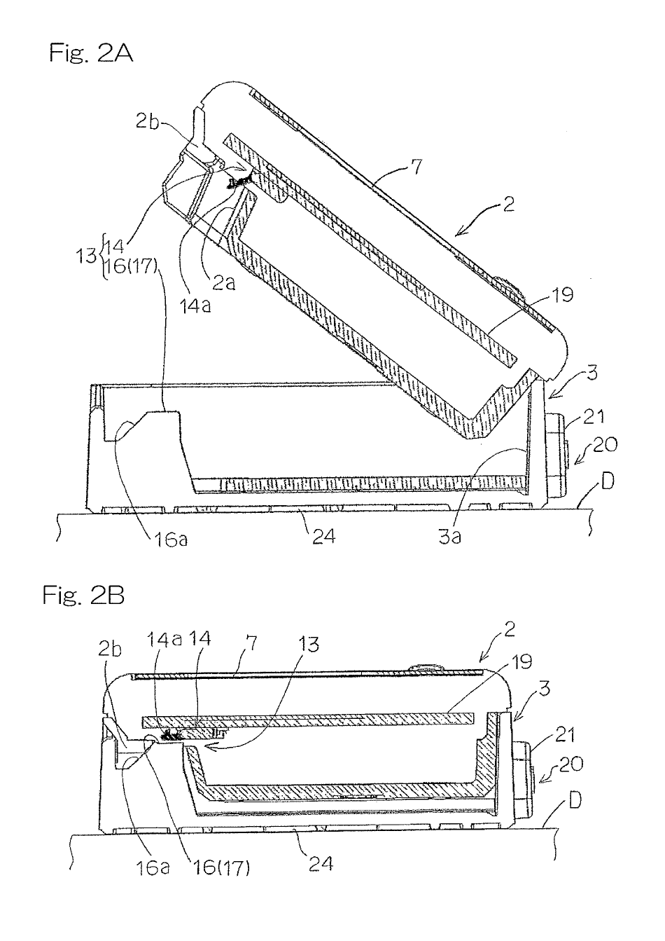

Hereinafter, the present invention will be described in detail in connection with preferred embodiments thereof with reference to the accompanying drawings. In particular, FIGS. 1A and 1B illustrate respective exploded views of a drive diagnosing device 1 designed according to a first preferred embodiment of the present invention, FIG. 2A illustrates an exploded view of the drive diagnosis device 1 as viewed from lateral side, and FIG. 2B is a structural diagram showing the drive diagnosing device in an assembled condition.

Referring to FIG. 1A, the drive diagnosing device 1 includes a portable device main body 2 and an installation holder 3 having a recessed space 3a for accommodating the device main body 2. The installation holder 3 is adapted to be disposed at an arbitrarily chosen site within an automotive vehicle, for example, at a dashboard D, and the device main body 2 is adapted to be removably received within the recessed space 3a of the installation holder 3. The installation holder 3 has its bottom surface provided with a fixture material (best shown in FIGS. 2A and 2B) such as, for example, a double-sided adhesive tape 24. The drive diagnosing device 1 is of a substantially rectangular boxlike configuration and assumes, when placed on a flat surface area of the dashboard D in the automotive vehicle, a substantially horizontally laid position with its longitudinal sense held generally or substantially parallel to the flat surface area of the dashboard D. It is, however, to be noted that that the drive diagnosing device 1 may be placed in an upright position with one of its opposite ends resting on the flat surface area of the dashboard D, in which case the drive diagnosis device 1 is placed while extending upright relative to the dashboard D.

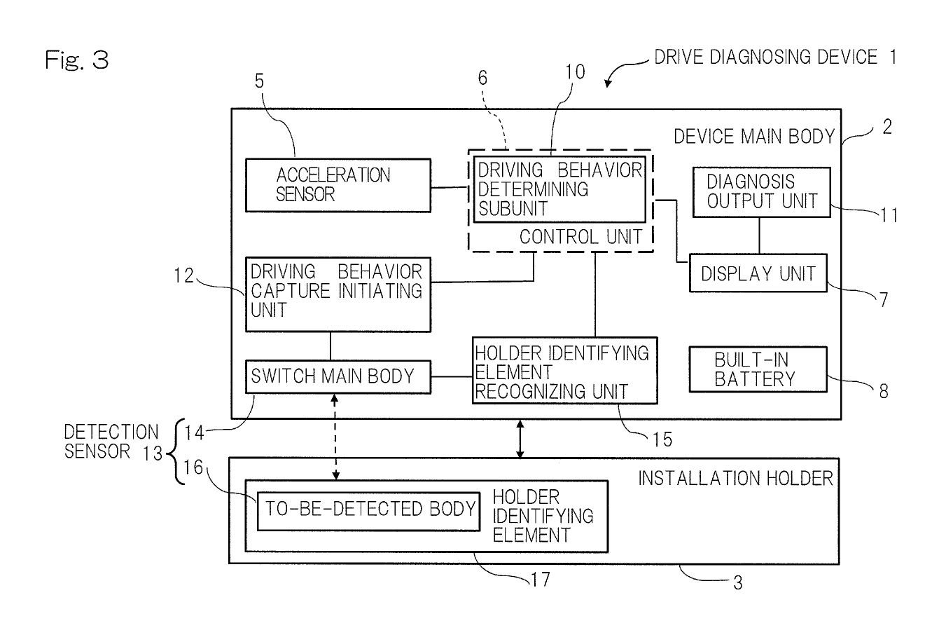

As shown in FIG. 3, the device main body 2 includes an operation detecting sensor 5 such as, for example, an acceleration sensor for detecting an operation such as, for example, an acceleration of an automotive vehicle to acquire a driving behavior, a control unit (microcomputer) 6, a display unit 7, and a battery 8 for supplying an electric power to the device. The device main body 2 is electrically powered by the built-in battery 8 and is kept in a switched-on state at all times with the electric power from the built-in battery 8 supplied thereto. Also, the device main body 2 also includes an annunciator for issuing an alarm, a memory and an electric power source switch, all of those elements being not shown. By the electric power source switch, the device main body 2 is deenergized, i.e., switched off when the device main body 2 is not in use for a long period.

The drive diagnosing device 1, without concurrently utilizing the various sensors such as discussed in connection with the conventional device, is of a type capable of acquiring the driving behavior from the acceleration of an automotive vehicle that is detected only by the acceleration sensor 5 used as the operation detecting sensor, and the control unit 6 referred to above calculates a determination on the basis of the driving behavior so acquired to thereby diagnose the drive. The driving behavior may include a brake pedaling, an accelerator pedaling and a steering wheel manipulation.

The acceleration sensor 5 is used to collect data (G display) on three accelerations acting in three axes, including a forward and rearward direction (direction parallel to the longitudinal sense of the automotive vehicle), a leftward and rightward direction (lateral directions generally or substantially orthogonal to the longitudinal sense of the automotive vehicle) and an up and down direction (vertical direction generally or substantially orthogonal to the longitudinal sense of the automotive vehicle) to thereby acquire the driving behavior of the automotive vehicle and is capable of detecting some of the driving behaviors, for example, a dangerous behavior such as, for example, an abrupt accelerator pedaling, an abrupt brake pedaling and an abrupt steering wheel manipulation, and a smooth driving behavior such as, for example, a smooth start and a smooth halt. This acceleration sensor 5 is electrically energized at all times with the electric power supplied from the battery 8 and is, hence, kept in a switched-on condition at all times.

It is to be noted that although in the practice of this preferred embodiment now under discussion, an acceleration sensor is used for the operation detecting sensor and the driving behavior is acquired from the acceleration of the automotive vehicle, a gyro-sensor may be employed in place of the acceleration sensor to acquire the driving behavior and, alternatively, a GPS sensor may be employed in place of the acceleration sensor to acquire the driving behavior from an acceleration brought about by a time dependent change in speed of the automotive vehicle.

The drive diagnosing device 1 of the present invention make use of a lithium battery for the battery 8 and, therefore, no wiring is needed to supply an electric power from the automotive vehicle and it can be easily and conveniently installed at any desired or arbitrarily chosen site within the automobile vehicle. The display unit 7 is comprised of, for example, a liquid crystal display (LCD) and/or a light emitting diode (LED) and is used to display results of diagnosis.

The control unit 6 is operable to control the device in its entirety and includes a driving behavior determining subunit 10. This driving behavior determining subunit 10 diagnoses the driving behavior by determining a safety drive or a dangerous drive on the basis of the driving behavior, for example, the consecutive number and average number of the smooth drive and the dangerous drive. A diagnosis output unit 11 is operable to output the result of diagnosis, cause it to be displayed through the display unit 7 and/or causes the annunciator to issue an alarm (warning) in the event of a dangerous driving.

The drive diagnosing device 1 referred to above also includes a placement detecting mechanism 13 for detecting mounting of the device main body 2 onto the installation holder 3 and a driving behavior capture initiating unit 12 for initiating capture of the driving behavior on the basis of the detection of the acceleration (action) of the automobile vehicle, which is fed from the acceleration sensor 5 to the control unit 6 subsequent to the detection of the mounting of the device main body 2 onto the installation holder 3, and subsequently causing determination of the driving behavior. The driving behavior capture initiating unit 12, upon detection of the device main body 2, outputs a placement detection signal to the control unit 6 and the control unit 6 then initiates the capture of the driving behavior on the basis of the inputting of the placement detection signal.

As shown in FIGS. 2A and 2B, the placement detecting mechanism 13 is in the form of a detection switch such as, for example, a lever (leaf) switch and is made up of a switch main body 14, which is provided on the side of the device main body 2, and a to-be-detected body 16 such as, for example, a projection provided on the side of the installation holder 3. In the instance now under discussion, on the assumption that an erroneous operation, brought about by vibrations, and/or alignment are within permissible limits, a contact type switch is employed therefor.

As best shown in FIG. 2A, the lever switch 13 is of such a design that the switch main body 14 is fitted to a support frames 19 on the side of the device main body 2, and the projection (to-be-detected body) 16 is formed at a position, which may be opposed to a lever 14a of the switch main body 14 when the device main body 2 is mounted, so as to extend upwards towards the side of the installation holder 3. The device main body 2 is provided with a guide portion 2a at a location below the lever 14a and, hence, the projection 16 can be guided along the guide portion 2a during the mounting of the device main body 2.

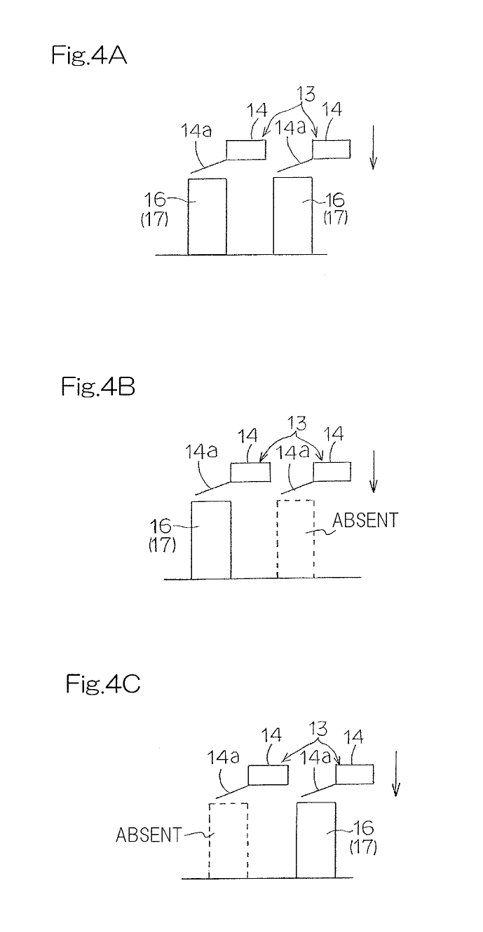

Since the projection 16, which is the to-be-detected body, is provided on the side of the installation holder 3, the structure thereof is simplified for the purpose of eliminating an electric power supply to the installation holder 3. As shown in FIGS. 4A to 4C, in the instance now under discussion, two lever switches 13 in combination with two projections 16 (as shown in FIG. 1A) are employed, but this is furthermore for the purpose of concurrent use with a holder identifying element 17 as will be described later. The mounting of the device main body 2 is detected when either one of the two lever switches 13 detects such mounting. It is to be noted that where the holder identifying element, which is provided separately, is independently used or where no holder identifying element is necessary, the single projection 16 is employed.

As shown in FIG. 1A, the use is made of a locking unit 20 for locking the device main body 2 to the installation holder 3 when and after the device main body 2 has been mounted onto the installation holder 3. This locking unit 20 may be of any known design and may, for example, include a push button 21, disposed at a front intermediate location on the side of the installation holder 3, a nail portion 25 and a spring (not shown) for urging the push button 21 and, on the other hand, the device main body 2 is provided with a button receptacle 22 and a nail engagement portion 26 (best shown in FIG. 1B) that is brought into engagement with the nail portion 25 at the time and after the device main body 2 has been mounted on the installation holder 3. Accordingly, when the push button 21 of the locking unit 20 best shown in FIG. 1A is pushed, the nail portion 25 is disengaged from the nail engagement portion 26 to allow the device main body 2 to be unlocked from the installation holder 3.

Also, the device main body 2 shown in FIG. 2A is provided with an engagement portion 2b at a location (on the left side as shown), spaced from a portion (on the right side as shown) where the locking unit 20 is formed, and a to-be-engaged portion 16a in the form of a recess is provided in the neighborhood of the projection 16 in the installation holder 3. At the time of mounting of the device main body as shown in FIG. 2B, the engagement portion 2b and the to-be-engaged portion 16a are brought into engagement with each other, and cooperatively with this engagement the device main body 2 can be firmly locked to the installation holder 3 by the locking unit 20. Accordingly, not only can any displacement of the device main body 2 from the installation holder 3 be avoided, but any vibration of the device main body 2 incident thereto can also be avoided.

When the device main body 2 is mounted on the installation holder 3, the projection 16, while being guided by the guide portion 2a, pushes the lever 14a of the switch main body 14 upwards to assume a switched-on state. At this time, the device main body 2 is locked to the installation holder 3 by the locking nit 20. When the lock is released upon depression of the button 21, not only is the device main body 2 separated from the installation holder 3, but also a switched-off state is assumed. So long as the device main body 2 is not mounted on the installation holder 3, the switched-off state is retained.

Although in describing the preferred embodiment of the present invention as above the detection switch has been shown and employed as a contact type lever switch, the present invention is not necessarily limited thereto and a magnet switch or a limit switch may be employed in place of the contact type lever switch. Also, the detection switch may be employed in the form of, for example, a contact type detection sensor (photo interrupter) capable of detecting a light interruption on a non-contact basis. Even in this case, a light projecting and receiving device for the detection sensor is disposed on the side of the device main body 2 and the to-be-detected body is disposed on the side of the installation holder 3.

The installation holder 3 shown in FIG. 1A is prepared in a number of types in dependence with types of the automotive vehicle, all of which have respective holder identifying elements 17 while the device main body 2 includes a holder identifying element recognizing unit 15 for recognizing the particular holder identifying element 17. As shown in FIGS. 4A to 4C, in the example now under discussion, the lever switch 13 used for the mounting detection is provided two in number and used one for each of holder identifications, and the lever switch 13 is concurrently used for the mounting detection and for the holder identification.

Due to the use of the two lever switches 13 and the correspondingly two projections 16 (17), three types of installation holders 3 can be recognized and combinations of the presence or absence of the two projections 17 as the respective holder identifying element are defined for the specific installation holder 3. By way of example, an arrangement in which the two projections 17 are disposed at H (presence) and H (presence) as shown in FIG. 4A is allocated No. 1; an arrangement in which they are disposed at H (presence) and L (absence) as shown in FIG. 4B is allocated No. 2; and an arrangement in which they are disposed at L (absence) and H (presence) as shown in FIG. 4C is allocated No. 3. Using these combinations of detection, the installation holder 3 is identified. For example, when the switch main bodies 14 detects simultaneously H (presence) and H (presence) of the projections 17, respectively, No. 1 installation holder 3 is hence identified.

Since in this instance the lever switch 13 is concurrently used concurrently for the mounting detection and for the holder detection, the mounting detection of the device main body 2 on the installation holder 3 and a holder identification among the plurality of installation holders can be easily accomplished with a simplified structure.

It is to be noted that as the holder identifying element the projection 17 may be employed three or more in number, in which case, by increasing the number of the combinations of presence or absence thereof, a number of installation holders 3 can be identified.

Thus, by identifying the installation holder 3 fitted to the automotive vehicle, the type of the automotive vehicle can be recognized. Since depending on the type of automotive vehicle the site, at which the installation holder 3 is fitted, may vary and it may occur that the installation angle thereof may also vary, by correcting an acceleration data from the acceleration sensor 5 within the device main body 2 for each type of the automotive vehicle the driving behavior may require correction, but when as a result of identification of the holder 3 the installation angle of the device is known, the correction of the acceleration data become easy to accomplish. Accordingly, the type of the installation holder 3 can be recognized for each type and, therefore, the driving behavior appropriate to the type of the particular type of the automotive vehicle can be easily corrected.

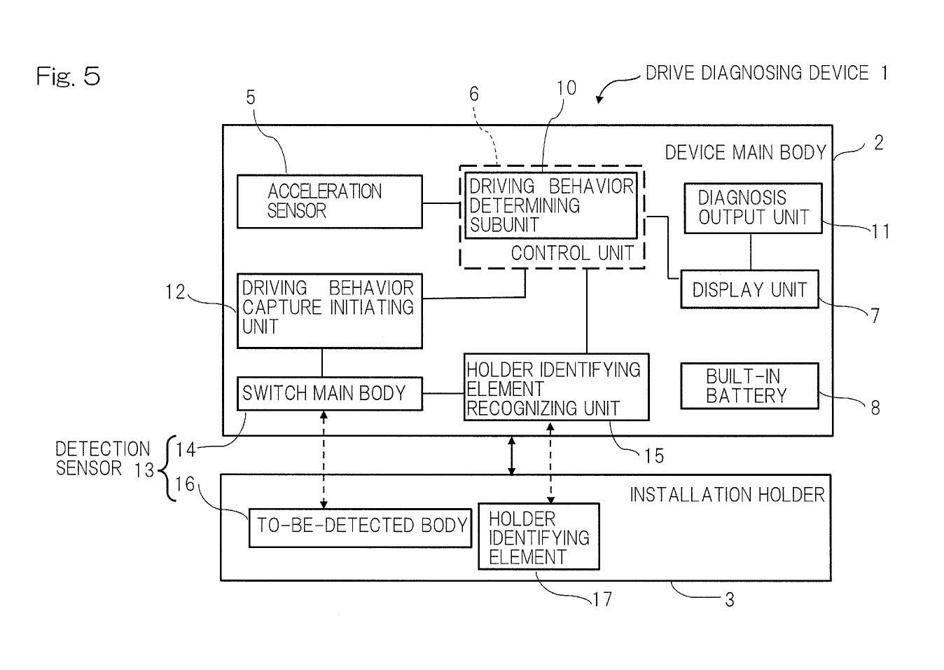

FIG. 5 illustrates a block diagram showing the drive diagnosing device 1 designed in accordance with another preferred embodiment of the present invention. While in the practice of the previously described first embodiment of the present invention, the contact type lever switch is used and is made operable concurrently for the holder identification and for the mounting detection, in the practice of the second embodiment the concurrent use of the lever switch for the holder identification and for the mounting detection is eliminated and, instead thereof, the holder identification is provided separate from the device detection. Other structural features than those described above are similar to those shown and described in connection with the previously described first embodiment of the present invention.

By way of example, as the holder identifying element, beside the contact type as hereinbefore referred to, a non-contact type such as, for example, bar codes or an IC card can be used. Even in this case, a read-out device is disposed on the side of the device main body 2 and the bar codes or the IC card is disposed on the side of the installation holder 3.

Since as hereinabove described the present invention is powered by the battery built in the device and can be carried from place to place and the operation detecting sensor for acquiring the driving behavior is held in a constantly driven condition, the convenience and the handlability of the device can be enhanced. Along therewith, since the placement of the device main body at the arbitrarily chosen site within the automotive vehicle is detected, a distinction between a condition, in which the device main body is installed within the automotive vehicle, and a condition, in which the device main body is being transported and is not therefore installed, can be easily accomplished. Also, since by the drive behavior capture initiating unit and after the placement detection of the device main body, capture of the driving behavior is initiated and the driving behavior is hence determined, the calculation in the control unit is minimized as small as possible and the power consumption of the battery can be minimized. In view of this, with the built-in battery powered, portable device, the reliability of the driving behavior is increased owning to the distinction of the installation condition of the device main body and, while energy saving is achieved, the convenience and the handlability of the device can be enhanced.

Although in each of the preferred embodiments of the present invention discussed hereinabove, the use has been made of the installation holder 3 on which the mounting main body 2 is mounted, the installation holder 3 may be dispensed with. In such case, the device main body 2 is directly fitted to the arbitrarily chosen site such as, for example, the dashboard D inside the automobile vehicle by means of a fixture material such as, for example, a double sided adhesive tape or a tape identified by the trademarked “Magic Tape”. The detection that the device main body 2 is directly installed, if, for example, the installation angle of the device main body 2 is known, is accomplished by detecting an installed condition thereof through the acceleration sensor.

Besides, as a detecting method for detecting the direct installation of the device main body 2, the installation detection of the device main body 2 can be accomplished by the use of an electric wave such as, for example, a key authentication wave at the time of an engine start or an automotive vehicle information (vehicle speed, the rotational number, fuel use amount and so on) to identify the automotive vehicle. Also, where peculiar light and/or sound exist inside each automotive vehicle, the automotive vehicle can be identified by detecting them.

It is to be noted that although in describing each of the preferred embodiments of the present invention, the installation holder 3 has been described as identified separately, the holder identification may be dispensed with if so required.

In addition, arrangement may be made that the drive diagnosing device 1 is designed to have a communication function so that a diagnosis output of the driving behavior and/or the type of the installation holder 3 can be communicated with.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Drive diagnosing device
2 . . . Device main body
3 . . . Installation holder
5 . . . Operation detecting sensor (Acceleration sensor)
6 . . . Control unit
8 . . . Built-in battery
10 . . . Driving behavior determining subunit
12 . . . Driving behavior capture initiating unit
13 . . . Placement detecting mechanism (Detection switch)
14 . . . Switch main body
15 . . . Holder identifying element recognizing unit
16 . . . To-be-detected body
17 . . . Holder identifying element

What is claimed is:

1. A drive diagnosing device which comprises a portable device main body comprising a control unit that is electrically powered by a battery built in the device and operable to acquire a driving behavior from operation of an automotive vehicle, detected by an operation detecting sensor, and then to determine the driving behavior to diagnose such drive, the device main body being installed at an arbitrarily chosen site inside the automotive vehicle:
in which the operation detecting sensor is kept in a constantly drive condition;
further comprising a driving behavior capture initiating unit to cause the control unit to initiate capture of the driving behavior, after mounting of the device main body at the arbitrarily chosen site within the automotive vehicle has been detected, on the basis of detection of an automotive vehicle operation from the operation detecting sensor and to determine the driving behavior.

2. The drive diagnosing device as claimed in claim 1, which comprises an installation holder installed at the arbitrarily chosen site within the automotive vehicle and on which the device main body is removal mounted, and a placement detecting mechanism to detect the mounting of the device main body on the installation holder;
in which the driving behavior capture initiating unit initiates the capture of the driving behavior, after the detection of placement of the device main body onto the installation holder, to thereby determine the driving behavior.

3. The drive diagnosing device as claimed in claim 2, in which the placement detecting mechanism comprises a detection switch, a switch main body being disposed on the side of the device main body while a to-be-detected body is disposed on the side of the installation holder.

4. The drive diagnosing device as claimed in claim 2, in which the installation holder is provided in a number of types, each type having a unique holder identifying element, and in which the device main body includes a holder identifying element recognizing unit to recognize the holder identifying element.

5. The drive diagnosis device as claimed in claim 3, in which a plurality of the to-be-detected bodies form the holder identifying element.

6. The drive diagnosing device as claimed in claim 1, in which the operation detecting sensor is selected from the group consisting of an acceleration sensor, a gyro sensor and a GPS sensor.
